(19) United States
(12) Patent Application Publication
(10) Pub. No.: US 2012/0173078 A1
(43) Pub. Date: Jul. 5, 2012

(54) FUEL SYSTEM FOR AIRCRAFT ENGINES

(76) Inventors: Michael Louis Everett, El Paso, TX (US); Louis Jackson Everett, El Paso, TX (US); Mario Ruiz, JR., El Paso, TX (US)

(21) Appl. No.: 13/414,914

(22) Filed: Mar. 8, 2012

Related U.S. Application Data
(63) Continuation-in-part of application No. 12/959,418, filed on Dec. 3, 2010.
Application No. 12/959,418 is a continuation-in-part of application No. 13/036,134, filed on Feb. 28, 2011.
(60) Provisional application No. 61/267,075, filed on Dec. 6, 2009.
(60) Provisional application No. 61/309,857, filed on Mar. 2, 2010.

(51) Int. Cl. G06F 19/00

(52) U.S. Cl. 701/36

(57) ABSTRACT

A fuel pump system for an aircraft engine having a booster pump that is always on during maneuvers and malfunction of primary fuel pump is disclosed. During fuel pressure loss, the boost pump and warning systems for the pilot are activated. The booster pump off and on up process are continued up to a maximum of a predefined number of times at a predetermined time interval in order to confirm that the low pressure was not due to an air bubble, or sensor glitch. The cyclic on and off process is performed only when the aircraft is at a safe altitude above ground level. If the aircraft is in close proximity to the ground and the pressure drops, the boost pump will be activated and remain on without cycling until the aircraft is at a safe altitude, or the aircraft is parked and the engine has been turned off.

### REFERENCE TO RELATED APPLICATION

This patent is a Continuation-In-Part of U.S. patent application Ser. No. 12/959,418, entitled “METHOD AND APPARATUS FOR AUTOMATICALLY CONTROLLING AIRCRAFT FLIGHT CONTROL TRIM SYSTEMS”, filed Dec. 3, 2010, which is a continuation of U.S. Provisional Patent Application Ser. No. 61/267,075, which was filed on Dec. 6, 2009. This patent application is also a Continuation-In-Part of U.S. patent application Ser. No. 13/036,134, entitled “METHOD AND APPARATUS FOR AUTOMATICALLY CONTROLLING AIRBORNE VEHICLE LIGHTING SYSTEMS” filed on Feb. 28, 2011, which in turn is a continuation of U.S. Provisional Patent Application Ser. No. 61/309,857, which was filed on Mar. 2, 2010. The disclosures of the preceding applications are all incorporated herein by reference in their entirety.

### TECHNICAL FIELD

Embodiments are generally related to fuel systems. Embodiments also relate to the field of fuel pump system for aircraft engines. Embodiments additionally relate to fuel pump system and method for safe operation of aircraft during critical maneuvers such as takeoff, landing, fuel tank transfers and malfunctions such as fuel pressure drop.

### BACKGROUND OF THE INVENTION

Jet fuel and aviation gasoline are usually supplied to the engines of an aircraft by an engine driven pump. However, because the fuel tanks are usually low relative to the engine, a tank pump is also normally required to pump the fuel to the engine under pressure to prevent cavitation in the engine driven pump and to minimize wear and improve the efficiency thereof.

A typical aircraft has a primary mechanical fuel pump mounted on each engine. In such aircraft fuel systems, for flight safety reasons, an electric boost or back-up pump for each engine are also provided. In the event of a failure of the primary mechanical fuel pump, or a drop-off in pressure, the booster pump can still provide sufficient fuel line pressure to effect movement of the fuel from tank-to-tank and from tank to the engine.

The mechanical pump works as long as the engine is on and is considered the primary pump. The electric boost pump is for back-up purposes, and is used for engine starting, as well as fuel transfers etc. For safety, the boost pump should be on during critical maneuvers such as takeoff, landing, fuel tank transfers, and any other operation determined by aircraft manufacturer, such as low level flight, in flight engine failure, etc.

Such boost pumps should be manually activated during maneuvers, as well as in the event that the primary fuel pump has malfunctioned (evidenced by a significant drop in fuel pressure, in flight). Manual activation of booster pump may not be quick as by the time the human operator identifies the fuel pressure drop and activates the booster pump, the fuel pressure may reach below the minimum for safe operation. Therefore a need exists for an advanced fuel pump system that can automatically activate and deactivate the booster pump when needed and ensure aircraft safety by identifying significant fuel pressure drop sooner than a human operator.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for fuel systems.

It is another aspect of the disclosed embodiments to provide for a fuel pump system for aircraft engines.

It is a further aspect of the present invention to provide for a fuel pump system and method for safe operation of aircraft during critical maneuvers such as takeoff, landing, fuel tank transfers and malfunctions such as fuel pressure drop.

The aforementioned aspects and other objectives and advantages can now be achieved as described herein A fuel pump system for an aircraft engine having a booster pump that is always on during maneuvers and malfunction of primary fuel pump is disclosed. During fuel pressure loss, the boost pump and warning systems for the pilot are activated. The booster pump off and on process are continued up to a maximum of a predefined number of times at a predetermined time interval in order to confirm that the low pressure was not due to an air bubble, or sensor glitch. The cyclic on and off process is performed only when the aircraft is at a safe altitude above ground level. If the aircraft is in close proximity to the ground and the pressure drops, the boost pump will be activated and remain on without cycling until the aircraft is at a safe altitude, or the aircraft is parked and the engine has been turned off.

The system ensures that the booster pump is always on during critical maneuvers, as well as in the event that the primary fuel pump has malfunctioned (evidenced by a significant drop in fuel pressure, in flight). In addition, it is able to activate the booster pump quicker than a human as it will identify significant fuel pressure drop sooner than a human operator.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a block diagram of an aircraft fuel system, in accordance with the disclosed embodiments;

FIG. 2 illustrates a flow diagram showing various operational states of an aircraft fuel system of FIG. 1, in accordance with the disclosed embodiments;

FIG. 3 illustrates a flow diagram showing various operational states of an aircraft fuel system of FIG. 1, in accordance with the disclosed embodiments;

FIG. 4 illustrates a flow chart of logical operational steps of a method for activating booster pump, in accordance with the disclosed embodiments;

FIG. 5 illustrates a flow chart of logical operational steps of a method for safe operation of aircraft during critical maneuvers and malfunctions, in accordance with the disclosed embodiments; and

FIG. 6 illustrates a flow chart of logical operational steps of a method for safe operation of aircraft during critical maneuvers and malfunctions, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

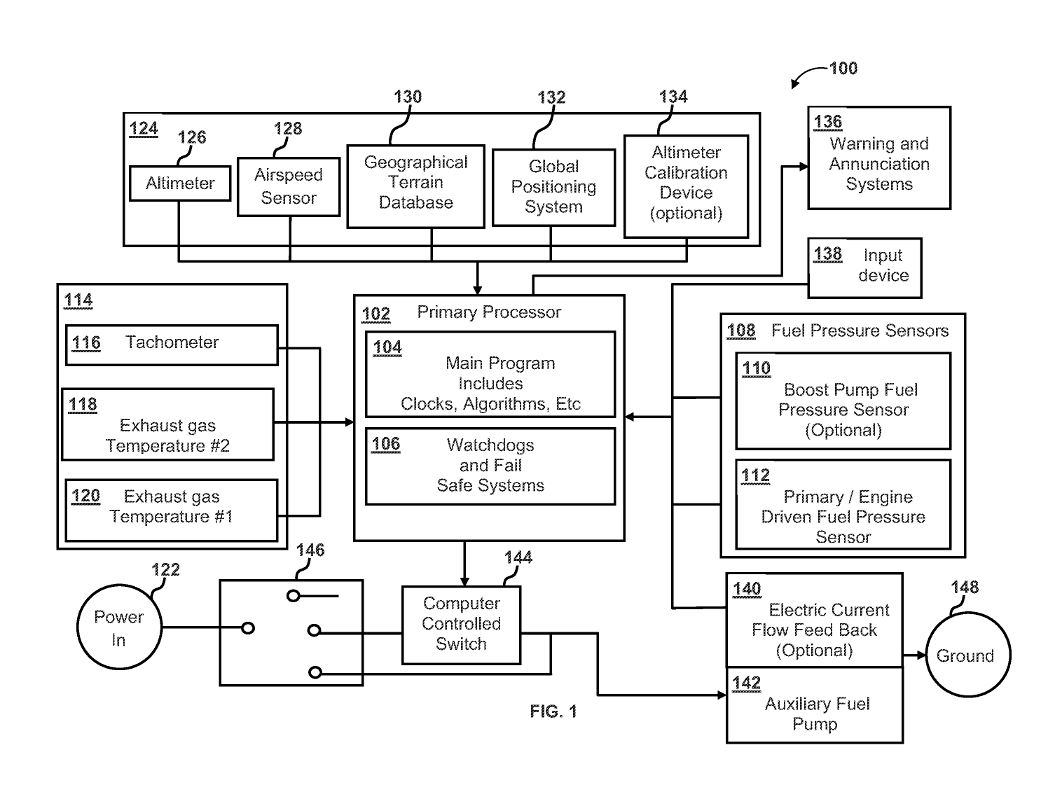

FIG. 1 illustrates a block diagram of a fuel system 100 for an airborne vehicle. The fuel system 100 includes a primary processor 102, various sensors such as fuel pressure sensors 108, location and behavior sensors 124 and speed and temperature sensors 114, a computer controlled switch 144 and warning and annunciation systems 136. The fuel system 100 also includes an input device 138, electric current flow feedback device 140, operator selector switch 146 and auxiliary fuel pump 142. The system automatically ensures safe operation of aircraft during critical maneuvers such as takeoff, landing, fuel tank transfers and malfunctions such as fuel pressure drop. The operator, for example pilot, can select automatic or manual or off modes of the fuel system 100 by selecting any one of the modes such as automatic or On or Off by operating the operator selector switch 146. Different power sources such as engine driven AC generators, auxiliary power units (APUs), external power and ram air turbines can be utilized as power in 122 to power the aircraft electrical systems. The auxiliary fuel pump 142 and electric current flow feedback device 140 are connected to the ground 148. The input device 138 can be utilized to reset alarm and the system values.

The primary processor 102 receives inputs from various sensors and includes the capability of identifying when specific electric boost or back-up pump should be activated or deactivated based on the current operating state of the vehicle. The configuration of which state to activate or deactivate these pumps is reconfigurable based upon pilot, operator, manufacturer, or other parties requirements.

The primary processor 102 includes the main program 104 for operating the system 100. Main program 104 includes all clocks and algorithms for system operation. The primary processor 102 also includes watchdogs and fail safe systems 106 to bring the system 100 back from the unresponsive state into normal operation. The fuel pressure sensors 108 include a boost pump fuel pressure sensor 110 and a primary or engine driven fuel pressure sensor 112. The location and behavior sensors 124 may include a vehicle altimeter 126, a vehicle airspeed sensor 128, a geographical terrain database 130, a Global Positioning System (GPS) 132, and altimeter calibration device 134. Speed and temperature sensors 114 are provided in order for the primary processor 102 to determine if the engine is running. These sensors may include an engine tachometer 114 and exhaust gas temperature probes 118, 120. The processor 102 activates the warning and annunciation systems 136 for the pilot on detecting malfunction of the system 100. The warning and annunciation systems 136 may include lights, buzzers, etc. The processor 102 receives input and data from various sensors located throughout the vehicle and sends activation and deactivation signals to booster pumps.

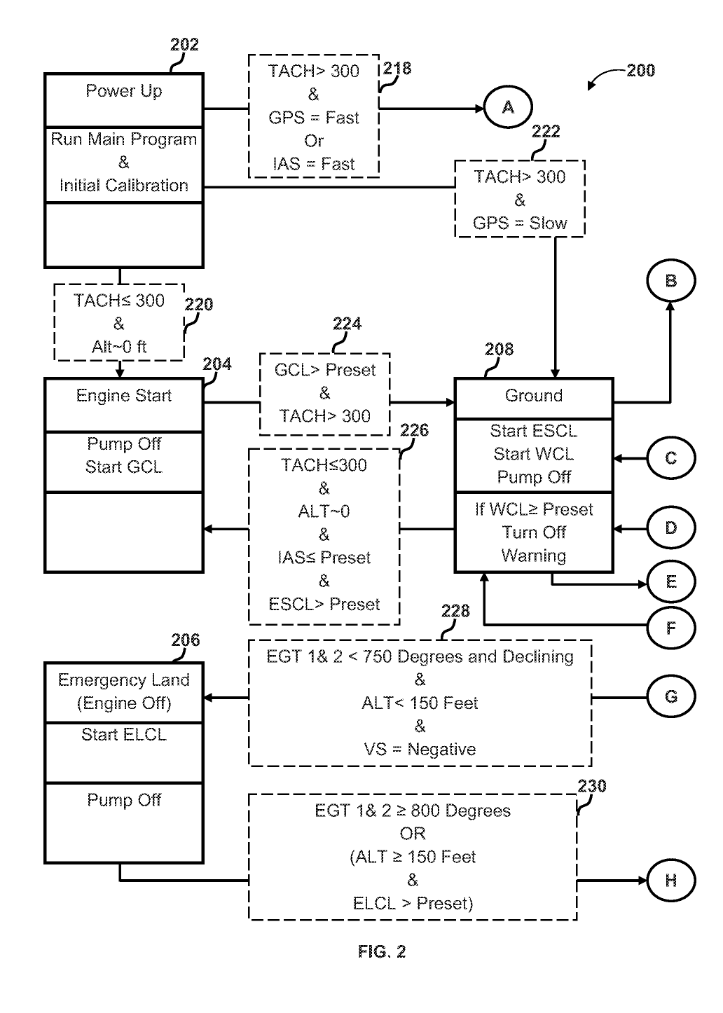

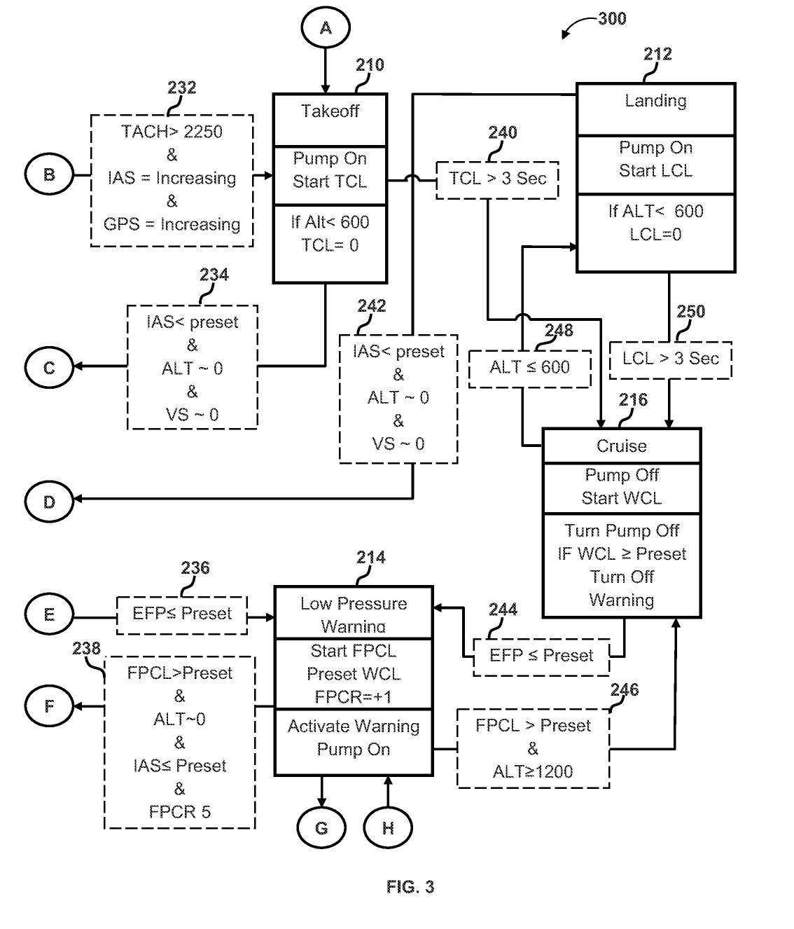

FIGS. 2 and 3 illustrate flow diagrams 200 and 300 showing various operational states of an aircraft fuel system of FIG. 1, in accordance with the disclosed embodiments. As illustrated at block 202, during power up state, the main program in the processor is run and the initial calibrations are made. The engine start state is depicted at block 204 in which the pumps are turned off and the GCL is started. During emergency landing (Engine Off) state as said at block 206, the pump is turned off and the ELCL is started. At the time of grounding, WCL and ESCL are started and pump is turned off. In case of take off state as illustrated at block 210, the pump is on and TCL is started. As depicted at block 214, during low pressure warning the FPCL is started, WCL is preset and FPCR is incremented by one. Also pump is on and warning system is activated at this state. In case of cruise state as depicted at block 216, the pump is turned off, WCL is started. During landing as said at block 212, pump is turned ON and LCL is started.

Various operating states and its conditions are:

As shown at block 218, in an exemplary embodiment, from power up state to takeoff state:

### TACH>300 and GPS=Fast and IAS=Fast

As shown at block 220, from power up state to engine start state:

### TACH≦300 and Alt˜0 ft

As shown at block 222, from power up state to Ground state:

### TACH>300 and GPS=Slow

As shown at block 224, from engine start state to ground state:

### GCL>Preset and TACH>300

As shown at block 226, from ground state ate to engine start state:

### TACH≦300 and ALT˜0 and |AS≦Preset and ESCL>Preset

As shown at block 228, from low pressure warning state to Emergency Landing state:

### EGT 1& 2<750 Degrees and Declining and ALT<150 Feet and VS=Negative

As shown at block 230, from Emergency Landing state to low pressure warning state is:

### EGT 1& 2≧800 Degrees or (ALT≧150 Feet and ELCL>Preset)

As shown at block 232, from Ground state to takeoff state:

### TACH>2250 and |AS=Increasing and GPS=Increasing

As shown at block 234, from takeoff state to Ground state:
|AS<preset and ALT˜0 and VS˜0
As shown at block 236, from Ground state to low pressure warning state is:

### EFP≦Preset

As shown at block 238, from low pressure warning state to Ground state is:

### FPCL>Preset and ALT˜0 and |AS≦Preset and FPCR 5

As shown at block 240, from takeoff state to cruise state is:

### TCL>3 Sec

As shown at block 242, from landing state to ground state is:
|AS<preset and ALT˜0 and VS˜0
As shown at block 244, from cruise state to low pressure warning state is:

### EFP≦Preset

As shown at block 246, from low pressure warning state to cruise state is:

### FPCL>Preset and ALT≧1200

As shown at block 248, from cruise state to landing state is:

### ALT≦600

As shown at block 250, from landing state to cruise state is:

### LCL>3 Sec

The fuel system 100 utilizes the aircraft sensors and the GPS to identify where the aircraft is geographically, as well its proximity to the terrain. When the aircraft is on the ground state and is not taking off the pump remains off, unless the engine is on and the fuel pressure is below the minimum for safe operation. If the Aircraft begins to accelerate under high power (takeoff), the pump is activated. As soon as the aircraft climbs above a predetermined altitude above ground level the pump is turned off. The pump will remain off until the aircraft returns to close proximity to the ground, or until the fuel pressure drops. Upon landing (plane on ground, airspeed, GPS speed, and Power settings low) the pump will be deactivated unless it was active due to low pressure warning, in which case it will remain on until the engine is turned off and the plane comes to a stop (on ground only).

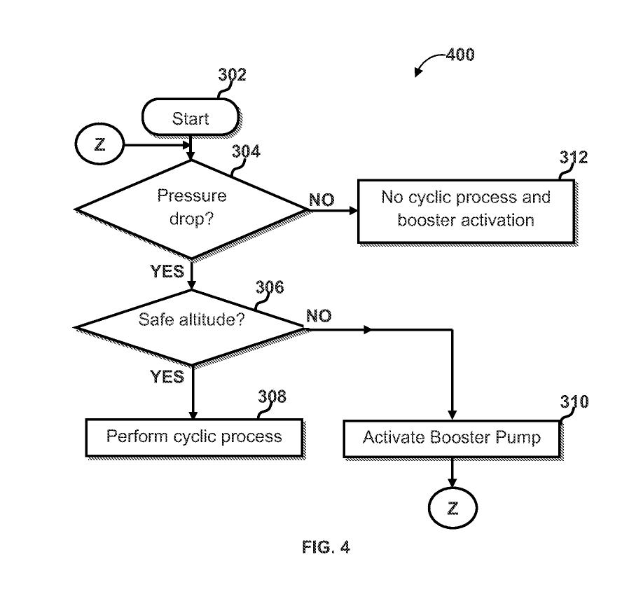

FIG. 4 illustrates a flow chart 400 of logical operational steps of a method for activating booster pump, in accordance with the disclosed embodiments. The method begins, as illustrated at block 302. As said at block 304 and 306 fuel pressure drop and aircraft safe altitude are checked. The booster pumps are activated and deactivated in a cyclic manner in order to confirm any malfunction of the fuel system 100 depicted in FIG. 1. Such cyclic process will only occur when the aircraft is at a safe altitude above ground level and there is pressure drop as said at block 308. As said at block 310, when the aircraft is in close proximity to the ground say 2,000 feet above ground and the pressure drops, the boost pump will be activated and remain on without cycling until the aircraft is at a safe altitude, or the aircraft is parked and the engine has been turned off (on the ground only). The cyclic process is not performed when there is no fuel pressure drop as said at block 312.

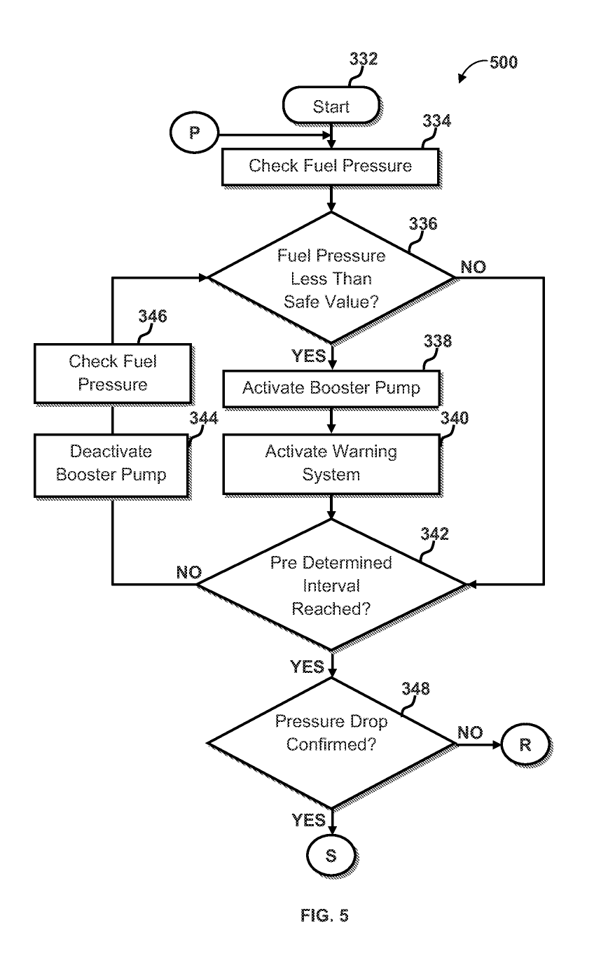

FIG. 5 illustrates a flow chart 500 of logical operational steps of a method 500 for safe operation of aircraft during critical maneuvers and malfunctions, in accordance with the disclosed embodiments. The method begins, as illustrated at block 332. As illustrated at block 334, the fuel pressure is sensed using fuel pressure sensors 108 depicted in FIG. 1. In the event that the boost pump is activated due to fuel pressure loss as said at block 338, the system will activate warning systems for the pilot (light and buzzer) as depicted at Block 340. Then the booster pump is deactivated or turned off as said at block 344. The cycle process of turning the pump off and back on up to a maximum of a predefined number of times at a predetermined time interval, say 5 cycles, and 30 seconds is performed as said at block 342. As said at block 336, the cyclic process is performed only when the fuel pressure is less than the safe value. If the pressure suddenly falls, the pump will be activated upon the pressure drop but will be deactivated say 30 seconds later to check the fuel pressure as illustrated at block 346. If pressure begins to drop again, the pump will immediately be reactivated (the reactivation is almost immediate and occurs before the fuel pressure reaches a dangerous level). This procedure will repeat up to predefined number of times say 5 times. The cyclic process confirms whether the low pressure is not due to an air bubble, or sensor glitch as depicted at block 348.

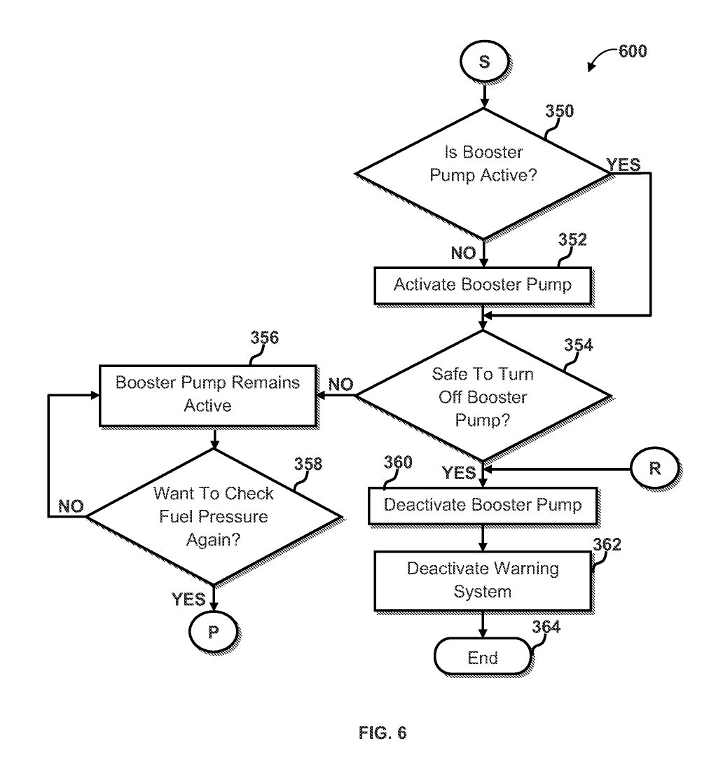

FIG. 6 illustrates a flow chart 600 of logical operational steps of a method for safe operation of aircraft during critical maneuvers and malfunctions, in accordance with the disclosed embodiments. After confirming the pressure drop, the system will check whether the booster pump is active, as said at block 350. Then, if the booster pump is not active it is activated as said at block 352 and remains active for the remainder of the flight unless the pilot cycles the over-ride switch or the operator control switch 146 as depicted in FIG. 1. This feature is intended to ensure that the low pressure was not the result of a sensor glitch or temporary issue resulting from tank transfers, air bubbles, etc. As illustrated at block 354, the system checks whether it is safe to turn off the booster pump. When it is safe to turn off booster pump, the booster pump and warning system are deactivated as said at block 360 and 362 respectively. Otherwise the booster pump remains active as illustrated at block 356. The system once again checks fuel process drop as said at block. Finally the process ends as said at block 364.

Note that for clarity a single flow chart is split into two flow charts 500 and 600. Also note that the flow diagrams illustrating various operating states and conditions of the system are also split into two flow diagrams 200 and 300 for clarity.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A vehicle fuel system comprising:
a fuel pump system having at least one primary fuel pump and at least booster fuel pump mounted on at least one engine of a vehicle;
a processor for automatically controlling activation and deactivation of said booster fuel pump based on an operating mode of said vehicle, wherein said processor performs a cyclic process of activation and deactivation of said booster fuel pump up to a predefined number of times at a predetermined time interval in order to ensure whether malfunction of said fuel pump system has occurred or not; and
at least one sensor operatively connected to said processor for sensing said operating mode of said vehicle.

2. The apparatus of claim 1, wherein said operating mode is determined by said processor based on a three-dimensional geographical position of said vehicle.

3. The apparatus of claim 2, further comprising:
a GPS sensor operatively connected to said processor to determine said three dimensional geographical position wherein said three-dimensional geographical position includes both an altitude above ground and a geographical position.

4. The apparatus of claim 1, wherein said at least one sensor comprises a vehicle speed sensor operatively connected to said processor to determine said operating mode.

5. The apparatus of claim 1, wherein said at least one sensor comprises a fuel pressure sensor for sensing pressure drop of said primary fuel pump.

6. The apparatus of claim 1, wherein said at least one sensor comprises an optional fuel valve position sensor for sensing opening and closing of fuel valves of said fuel pump system.

7. The apparatus of claim 1, wherein said at least one sensor comprises speed and temperature sensor for sensing speed and exhaust gas temperature of said engine.

8. The apparatus of claim 1, wherein said vehicle comprises an airborne vehicle.

9. The apparatus of claim 1, wherein said cyclic process occurs only when said vehicle is at a safe altitude above ground level.

10. The apparatus of claim 1, wherein said cyclic process does not occurs when said vehicle is at proximity to ground and fuel pressure drops.

11. A vehicle fuel system comprising:
a fuel pump system having at least one primary fuel pump and at least booster fuel pump mounted on at least one engine of a vehicle;
a processor for automatically controlling activation and deactivation of said booster fuel pump based on an operating mode of said vehicle, wherein said processor performs a cyclic process of activation and deactivation of said booster fuel pump up to a predefined number of times at a predetermined time interval in order to ensure whether malfunction of said fuel pump system has occurred or not; and
at least one sensor operatively connected to said processor for sensing said operating mode of said vehicle based on a three-dimensional geographical position of said vehicle.

12. The apparatus of claim 11, further comprising:
a GPS sensor operatively connected to said processor to determine said three dimensional geographical position wherein said three-dimensional geographical position includes both an altitude above ground and a geographical position.

13. The apparatus of claim 11, wherein said at least one sensor comprises a vehicle speed sensor operatively connected to said processor to determine said operating mode.

14. The apparatus of claim 11, wherein said at least one sensor comprises a fuel pressure sensor for sensing pressure drop of said primary fuel pump.

15. The apparatus of claim 11, wherein said at least one sensor comprises an optional fuel valve position sensor for sensing opening and closing of fuel valves of said fuel pump system.

16. The apparatus of claim 11, wherein said at least one sensor comprises speed and temperature sensor for sensing speed and exhaust gas temperature of said engine.

17. The apparatus of claim 11, wherein said vehicle comprises an airborne vehicle.

18. The apparatus of claim 1, wherein said cyclic process occurs only when said vehicle is at a safe altitude above ground level.

19. The apparatus of claim 11, wherein said cyclic process does not occurs when said vehicle is at proximity to ground and fuel pressure drops.

20. A method monitoring and controlling an aircraft fuel system, comprising:
providing a fuel pump system controlled by a processor and having at least one primary fuel pump and at least booster fuel pump mounted on at least one engine of a vehicle and at least one sensor providing operation of an aircraft;
monitoring operation of an aircraft with said at least one sensor and providing readings to said processor;
automatically controlling activation and deactivation of said booster fuel pump based on an operation of said aircraft, wherein said processor performs a cyclic process of activation and deactivation of said booster fuel pump up to a predefined number of times at a predetermined time interval in order to ensure whether malfunction of said fuel pump system has occurred or not, wherein activation and deactivation is based on three-dimensional geographical position of said aircraft including at least one of: GPS position, altitude, speed, fuel pressure, fuel valve position sensor, exhaust gas temperature.
